(19) United States
(12) Patent Application Publication
(10) Pub. No.: US 2017/0006916 A1
(43) Pub. Date: Jan. 12, 2017

(54) ATOMIZER AND ELECTRIC CIGARETTE

(71) Applicant: KIMREE HI-TECH INC., Tortola (VG)

(72) Inventor: Qiuming LIU, Huizhou, Guangdong (CN)

(21) Appl. No.: 14/646,087

(22) PCT Filed: Apr. 23, 2014
(86) PCT No.: PCT/CN2014/076003

§ 371 Date: May 20, 2015

(30) Foreign Application Priority Data
Apr. 3, 2014 (CN) 201420161281.4

(51) Int. Cl. A24F 47/00; H05B 3/03

(52) U.S. Cl. CPC A24F 47/008; H05B 3/03; H05B 2203/021; H05B 2203/003

(57) ABSTRACT

An atomizer and an electronic cigarette are provided. The atomizer includes: an atomizer cartridge, a liquid storage chamber, a liquid separation plate, an electric heating element, a cigarette liquid locking member, a first glass fiber cloth, and an atomizing electrode assembly. The electric heating element twists along the transverse direction of the atomizer, and is laid on the first glass fiber cloth, and the electric heating element laid on the first glass fiber cloth has a snakelike sheet structure. The cigarette liquid can be uniformly transferred to the electric heating element, and the volume of the aerosol is uniform. Furthermore, the quantity of the cigarette liquid transferred to the electric heating element is ensured to be uniform. In addition, the length of the electric heating element and the contact area of the electric heating element in contact with the first glass fiber cloth are effectively increased.

This application is the national phase of International Application No. PCT/CN2014/076003, titled “ATOMIZER AND ELECTRONIC CIGARETTE”, filed on Apr. 2, 2014, which claims the benefit of priority to Chinese Patent Application No. 201420161281.4 titled “ATOMIZER AND ELECTRONIC CIGARETTE”, filed with the State Intellectual Property Office of the PRC on Apr. 3, 2014, the entire disclosure of which are incorporated herein by reference.

### BACKGROUND

1. Field of the Disclosure

The present application relates to the technical field of electronic cigarettes, and particularly to an atomizer and an electronic cigarette which effectively increase the volume of aerosol.

2. Discussion of the Background Art

Reference is made to FIG. 1 for the structure of a conventional atomizer. As illustrated in FIG. 1, the atomizer is for atomizing a cigarette liquid to generate an aerosol for being inhaled by a user. In a specific arrangement, a glass fiber tube 102 is provided inside an atomizer cartridge 105, and a liquid storage cotton 101 for storing the cigarette liquid is coated at the outside of the glass fiber tube 102. A glass fiber wire 103 is provided inside the glass fiber tube 102. The glass fiber wire 103 has two ends passing through the glass fiber tube 102 and inserted into the liquid storage cotton 101, and an electric heating wire 104 in a column shape is wound around the glass fiber wire 103, the electric heating wire being for atomizing the cigarette liquid. The cigarette liquid inside the liquid storage cotton 101 can be transferred to the electric heating wire 104 via the glass fiber tube 102 and the glass fiber wire 103, and accordingly, the electric heating wire 104 atomizes the cigarette liquid to generate the aerosol.

Currently, the electric heating wire 104 has a diameter ranging from 0.08 mm to 0.13 mm, which is small, such that a contact area of the electric heating wire 104 in contact with the glass fiber wire 103 is small. The atomizing temperature of the cigarette liquid ranges from 220 Celsius degrees to 300 Celsius degrees. For increasing the aerosol volume to meet the requirement of a user with a big vital capacity, the current flowing through the electric heating wire 104 is increased to enable the electric heating wire 104, when energized, to reach a temperature ranging from 300 Celsius degrees to 600 Celsius degrees. However, such approach is apt to cause the liquid storage cotton 101 to be burnt, which negatively affects the service life of the electronic cigarette. Furthermore, increasing the aerosol volume may also be achieved by increasing the length of the electric heating wire 104. However, since the electronic cigarette is primarily for imitating a tobacco cigarette, it is preferred to have a size equal to that of the tobacco cigarette so that it is readily accepted by a user; hence, transverse section areas of the electronic cigarette and the glass fiber tube 102 inside the electronic cigarette are limited, the electric heating wire 104 can be lengthened in a limited scope, and accordingly, the aerosol volume can be increased in a limited scope as well through lengthening the electronic heating wire 104. In addition, if the electric heating wire 104 is too long, the cigarette liquid is likely not to be transferred to the center position of the electric heating wire 104, the cigarette liquid is atomized only by both ends of the electric heating wire 104, and consequently, the electric heating wire 104 at the center position is extremely likely to be burnt.

In the conventional technology, for increasing the aerosol volume, the electric heating wire 104 wound in a column shape may be longitudinally arranged, such that the axis of the electric heating wire 104 overlaps or is parallel to the axis of the atomizer. However, since the electric heating wire 104 is of soft nature and the electric heating wire 104 arranged by winding has spaces formed between spiral coils, if the electric heating wire is placed vertically, the spiral coils may be extremely likely to contact with each other due to gravity or vibration, such that power of the electric heating wire fluctuates largely, and further causing the aerosol volume to fluctuate largely, i.e., as the number of the spiral coils in contact with each other varies, the generated aerosol volume varies, resulting in an unstable aerosol volume. When the power is too big, the glass fiber wire 103 may be burnt; therefore, the desirable effect may not be achieved, the service life of the atomizer may be negatively affected, and reject ratio of products during manufacture is high.

### SUMMARY

In view of the above, an atomizer and an electronic cigarette are provided in the present application to effectively increase the volume of the aerosol.

An atomizer is provided, which includes:

an atomizer cartridge;

a liquid storage chamber, which is arranged inside the atomizer cartridge and is for storing a cigarette liquid;

a liquid separation plate, which is arranged at an opening of the liquid storage chamber and is provided with first through holes;

an electric heating element for atomizing the cigarette liquid to generate an aerosol;

a cigarette liquid locking member, which covers the liquid separation plate and is for locking the cigarette liquid to prevent the cigarette liquid in the liquid storage chamber from being overly transferred to the electric heating element;

a first glass fiber cloth, which is arranged between the cigarette liquid locking member and the electric heating element, covers the cigarette liquid locking member, and is for transferring the cigarette liquid to the electric heating element to be atomized; and

an atomizing electrode assembly, which is inserted at one end of the atomizer cartridge and electrically connected with the electric heating element;

where the electric heating element twists along the transverse direction of the atomizer and is laid on the first glass fiber cloth, the electric heating element laid on the first glass fiber cloth has a snakelike sheet structure, and a first side face of the electric heating element fits close to a surface of the first glass fiber cloth.

In the atomizer, a second glass fiber cloth is further provided at one side of the electric heating member and covers the electric heating element, the side of the electric heating member being away from the cigarette liquid locking member, the second glass fiber cloth abuts against the first glass fiber cloth and is for transferring the cigarette liquid to the electric heating element to be atomized.

In the atomizer, the atomizer electrode assembly includes;

a first outer electrode inserted in the atomizer cartridge;

an insulation ring arranged inside the first outer electrode; and

a first inner electrode inserted inside the insulation ring;

where the electric heating element having one end inserted between the first outer electrode and the insulation ring, and another end inserted between the first inner electrode and the insulation ring.

In the atomizer, the atomizer is made of a non-metallic material, an annular protrusion is provided on a circumferential surface of an inner wall of the atomizer cartridge, and a groove matching the protrusion is provided on an outer circumferential surface of the first outer electrode at a position corresponding to the position of the protrusion.

In the atomizer, the atomizer further includes:

a substrate made of a heat resistive material, abutting against the cigarette liquid locking member;

where the substrate has one side provided with a metal layer, and the metal layer is formed by printing or electroplating a metallic material on the substrate and serves as the electric heating element.

In the atomizer, the metal layer is an alloy layer made of a plurality of metallic materials.

In the atomizer, the substrate is provided with the alloy layer at one side close to the cigarette liquid locking member;

the alloy layer is provided with air holes for flowing of the aerosol; and

the substrate is provided with second through holes at positions corresponding to those of the air holes.

In the atomizer, the substrate is provided with the alloy layer at one side far away from the cigarette liquid locking member; and the substrate is provided with liquid holes at positions corresponding to a position of the alloy layer, the liquid holes being configured to transfer the cigarette liquid to the electric heating element.

In the atomizer, the substrate is a flexible printed circuit board or a ceramic board.

An electronic cigarette is provided, which includes an electronic cigarette body; where

the electronic cigarette body is provided with a suction end, any of the atomizers described above, and a battery rod assembly configured to supply power to the atomizer; and

the battery rod assembly is arranged on the electronic cigarette body at one end far away from the suction end, or the atomizer is arranged on the electronic cigarette body at one end far away from the suction end.

In the electronic cigarette,

the atomizer is coaxially arranged with the battery rod assembly, and the atomizer is detachably connected with the battery rod assembly.

In the electronic cigarette, the battery rod assembly includes:

a battery cartridge;

a battery accommodated inside the battery cartridge;

a second outer electrode and a second inner electrode respectively electrically connected with the battery, the second outer electrode being electrically connected with the first outer electrode, and the second inner electrode being electrically connected with the first inner electrode;

a sensor module configured to generate a triggering signal in response to an operation of the user; and

a microcontroller which is electrically connected with the sensor module and is configured to generate a control signal based on the triggering signal, the microcontroller controlling, through the control signal, the battery to supply power to the electric heating element.

In the electronic cigarette,

the suction end is formed by an extension of one end of the atomizer, the end of the atomizer being far away from the battery rod assembly; or,

the suction end is detachably connected to the end of the atomizer far away from the battery rod assembly.

In the electronic cigarette,

the suction end is formed by an extension of one end of the battery rod assembly, the end of the battery rod assembly being far away from the atomizer; or,

the suction end is detachably connected to the end of the battery rod far assembly away from the atomizer.

An atomizer and an electronic cigarette are provided according to the present application. The atomizer is provided with a cigarette liquid locking member for preventing the cigarette liquid in the liquid storage chamber from being overly transferred to the electric heating element. With the cigarette liquid locking member, the cigarette liquid can be uniformly transferred to the electric heating element and the aerosol atomized by the electric heating element is uniform. Furthermore, a first glass fiber cloth for transferring the cigarette liquid to the electric heating element to be atomized is provided covering the cigarette liquid locking member, with the first glass fiber cloth, the quantity of the cigarette liquid transferred to the electric heating element is further ensured to be uniform. In addition, the electric heating element having a snakelike sheet structure is arranged transversely to fit close to the first glass fiber cloth, which effectively increases the length of the electric heating element and the contact area of the electric heating element in contact with the first glass fiber cloth, and avoids the non-uniform aerosol volume and burning of the components due to gravity or vibration of the spiral coils in the conventional technology, such that the atomizer according to the present application, while increasing the aerosol volume in a large degree, may not have the components such as cigarette liquid locking member getting burnt, effectively ensures the service life and use safety of the atomizer, and increases the yield rate of the products.

### BRIEF DESCRIPTION OF THE DRAWINGS

For more clearly illustrating embodiments of the present application or the technical solution in the conventional technology, drawings referred to describe the embodiments or the conventional technology are briefly described hereinafter. Apparently, the drawings in the following description are only several embodiments of the present application, and for the person skilled in the art other drawings may be obtained based on these drawings without any creative efforts.

FIG. 1 is a schematic longitudinal sectional view showing the structure of a conventional atomizer;

FIG. 2 is a schematic longitudinal sectional view showing the structure of an atomizer according to a preferred embodiment of the present application;

FIG. 3 is a schematic exploded structural view showing the connection between elements of an atomizer according to a preferred embodiment of the present application;

FIG. 4 is a schematic view showing the structure of a first glass fiber cloth provided with an electric heating element, according to a preferred embodiment of the present application;

FIG. 5 is a schematic longitudinal sectional view showing the structure of an atomizer according to another preferred embodiment of the present application;

FIG. 6 is a schematic exploded structural view showing the connection between elements of an atomizer according to another preferred embodiment of the present application;

FIG. 7 is a schematic view showing the structure of an electric heating element according to another preferred embodiment of the present application;

FIG. 8 is a schematic view showing the structure of an electric heating element according to another preferred embodiment of the present application;

FIG. 9 is a schematic longitudinal sectional view showing the structure of of an atomizer according to another preferred embodiment the present application;

FIG. 10 is a schematic view showing the structure of an electric heating element according to another preferred embodiment of the present application;

FIG. 11 is a schematic view showing the structure of an electric heating element according to another preferred embodiment of the present application;

FIG. 12 is a schematic view showing the overall structure of an electronic cigarette according to a preferred embodiment of the present application; and

FIG. 13 is a schematic longitudinal sectional view showing the structure of an electronic cigarette according to another preferred embodiment of the present application.

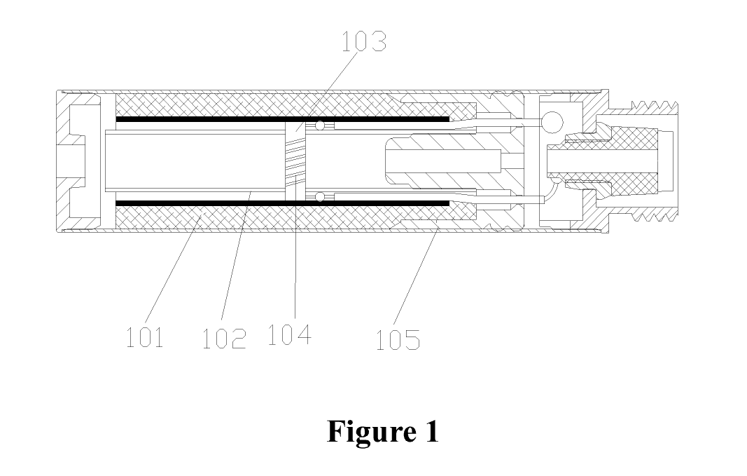

### DETAILED DESCRIPTION OF THE PREFERRED EMBODIMENTS

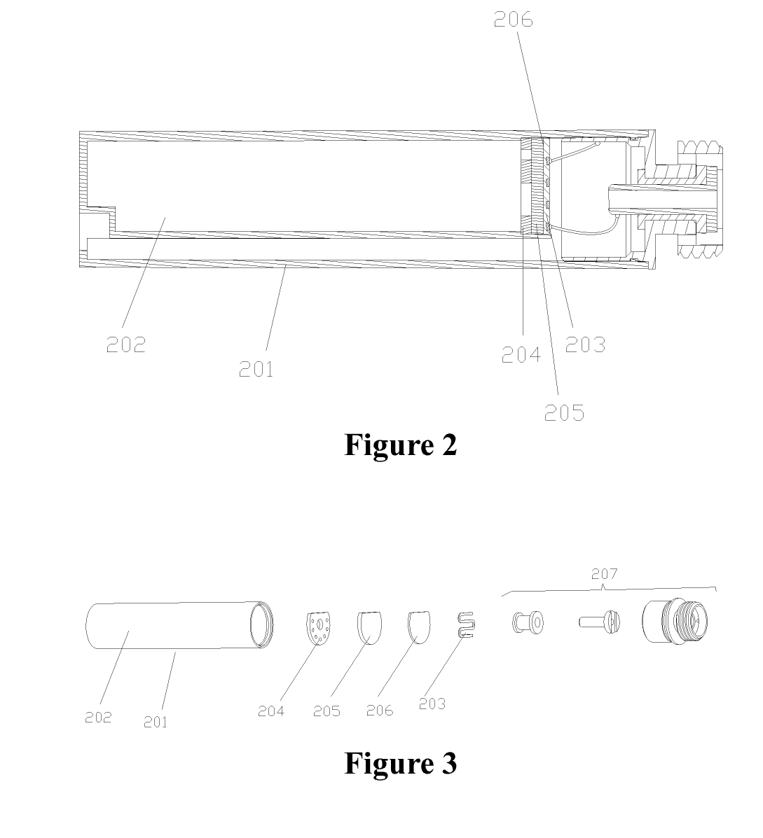

An atomizer is provided according to a first embodiment, reference may be made to FIGS. 2 and 3 for understanding the structure of the atomizer.

FIG. 2 is a schematic sectional view showing the structure of an atomizer according to the present application, and FIG. 3 is a schematic exploded view showing the connection between elements of an atomizer according to the present application.

The atomizer includes an atomizer cartridge 201, a liquid storage chamber 202, an electric heating element 203, a liquid separation plate 204, a cigarette liquid locking member 205, a first glass fiber cloth 206, and an atomizing electrode assembly 207.

The liquid storage chamber 202 is arranged inside the atomizer cartridge 201 and is for storing a cigarette liquid.

That is, the cigarette liquid may be sealedly stored inside the liquid storage chamber 202.

Specifically, a cigarette liquid may be directly stored in the liquid storage chamber 202, or a liquid storage cotton storing the cigarette liquid may be provided in the liquid storage chamber 202. Specific ways for storage are not detailed in the embodiment.

Compared with the conventional technology, in the embodiment, no liquid storage cotton or liquid guiding mechanism is required to be provided inside the liquid storage chamber 202, thereby improving the available volume for storing cigarette liquid in the liquid storage chamber 202, and further improving the quantity of cigarette liquid stored inside the liquid storage chamber 202, and effectively improving the duration of use of an electronic cigarette. The user is avoided from frequently changing the atomizer or adding cigarette liquid into the liquid storage chamber 202, which is convenient for use.

The electric heating element 203 is for atomizing the cigarette liquid to generate an aerosol.

The electric heating element 203 can atomize the cigarette liquid to generate the aerosol for being inhaled by the user.

Specifically, a plane where the electric heating element 203 locates may be perpendicular to or at a certain angle with respect to the axis of the atomizer cartridge 201.

For improving yield rate of products, facilitating assembly and having the volume of the aerosol atomized by the electric heating element 203 as large as possible, according to an embodiment, the plane where the electric heating element 203 locates is perpendicular to the axis of the atomizer cartridge 201.

The liquid separation plate 204 is arranged at an opening of the liquid storage chamber 202 and has a first through hole. As illustrated in FIGS. 2 and 3, the liquid separation plate 204 is configured to match the opening of the liquid storage chamber 202, and the liquid separation plate 204 is provided with a first through hole through which the cigarette liquid inside the liquid storage chamber 202 can be transferred to the electric heating element 203, where the cigarette liquid may not be overly transferred to the electric heating element 203. Hence, a leakage of the cigarette liquid is avoided, and the quantity of transferred cigarette liquid is ensured uniform. In this embodiment, the liquid separation plate 204 is detachably connected with the atomizer cartridge 201. Alternatively, the liquid separation plate may be integrally formed with the atomizer cartridge 201.

The cigarette liquid locking member 205 is arranged to cover the liquid separation plate 204, for locking the cigarette liquid to prevent the cigarette liquid in the liquid storage chamber 202 from being overly transferred to the electric heating element 203.

As illustrated in FIGS. 2 and 3, the cigarette liquid locking member 205 is arranged to match the liquid separation plate 204.

Preferably, the cigarette liquid locking member 205 may be made of materials such as cotton, acetate fiber or polyurethane, and may effectively store the cigarette liquid and may uniformly and constantly transfer the cigarette liquid to the electric heating element 203. Accordingly, the aerosol atomized by the electric heating element 203 is ensured with a uniform and constant amount, the concentration of the aerosol may not vary, and user experience in smoking may not be negatively affected.

More preferably, it is not required to arrange the cigarette liquid locking member 205 inside the liquid storage chamber 202, thus the space inside the liquid storage chamber 202 may not be occupied by the cigarette liquid locking member 205. Hence, the volume for storing cigarette liquid in the liquid storage chamber 202 is increased, thereby increasing the quantity of the cigarette liquid stored in the atomizer.

The first glass fiber cloth 206 is provided between the cigarette liquid locking member 205 and the electric heating element 203.

Specifically, the first glass fiber cloth 206 is made of a glass fiber material, which has excellent liquid guide performance and heat resistance performance, thereby well ensuring the reliability of the products.

Further, for allowing the first glass fiber cloth 206 to transfer the cigarette liquid to the electric heating element 203 uniformly, the first glass fiber cloth 206 is arranged covering the cigarette liquid locking member 205, so that the first glass fiber cloth 206 uniformly transfers the cigarette liquid on the cigarette liquid locking member 205 to the electric heating element 203.

Further, since the first glass fiber cloth 206 is arranged covering the electric heating element 203, when the electric heating element 203 reaches a high temperature during atomizing the cigarette liquid, the first glass fiber cloth 206 may dissipate the heat of the electric heating element 203 uniformly, to avoid the electric heating element 203 with a high temperature from burning the cigarette liquid locking member 205. Hence, the user do not need to worry about failure of the atomizer due to burning of the cigarette liquid locking member 205 even employing the atomizer according to the present embodiment for a long time.

The atomizing electrode assembly 207 (as shown in FIG. 3) is inserted at one end of the atomizer cartridge 201 and is electrically connected with the electric heating element 203. The atomizer electrode assembly 207 is configured to electrically connect with a battery of an electronic cigarette, to allow the battery to supply power to the electric heating element 203.

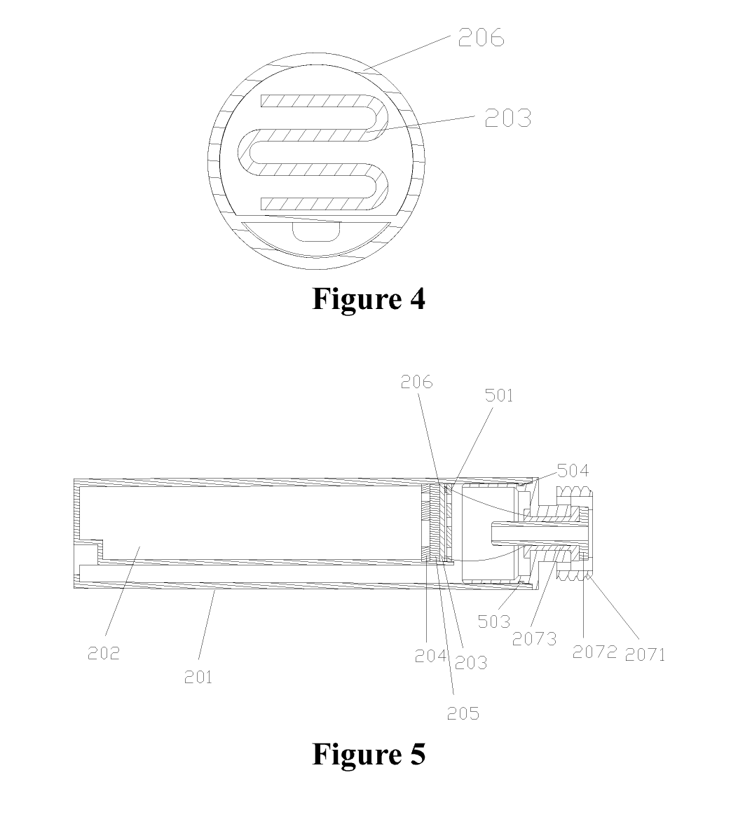

A specific structure of the electric heating element 203 is described in detail hereinafter in conjunction with an embodiment shown in FIG. 4.

FIG. 4 is a schematic view showing a structure of the first glass fiber cloth provided with the electric heating element.

The electric heating element 203 twists along the transverse direction of the atomizer, and is laid on the first glass fiber cloth 206, where the electric heating element 203 laid on the first glass fiber cloth 206 has a snakelike sheet structure, and a first side face of the electric heating element 203 fits close to a surface of the first glass fiber cloth 206. In this embodiment, the electric heating element 203 is perpendicular to an axial direction of the atomizer. Alternatively, the electric heating element 203 may be arranged to form an angle bigger than 0 degree with respect to the axial direction of the atomizer, to generate a transverse arrangement, that is, the electric heating element 203 is arranged not to be parallel to the axial direction of the atomizer, which is not limited here. Furthermore, as illustrated in FIG. 4, various portions of the electric heating element 203 according to the present embodiment are all in a same plane. It can be appreciated that, the electric heating element 203 may be arranged to have such a form that various portions thereof are respectively in different planes, which is not limited here.

Since the electric heating element 203 is laid on the first glass fiber cloth 206, and has a snakelike sheet structure fitting close to the first glass fiber cloth 206, the length of the electric heating element 203 and a contact area of the electric heating element 203 in contact with the first glass fiber cloth 206 are effectively increased, that is, it may achieve to arrange the electric heating element 203 having a big area on a small first glass fiber cloth 206. Hence, the electric heating element 203, when working, may generate a large amount of aerosol through atomization, and the user can inhale sufficient aerosol, thereby ensuring the user experience. Since the electric heating element 203 is arranged on the atomizer transversely, non-uniform aerosol volume and burning due to gravity or vibration of spiral coils in the prior technology are avoided and the yield rate of the products is increased.

It is to be cleared that, a specific approach for forming the electric heating element 203 is not limited in the present embodiment, so long as the electric heating element 203 can be laid on the first glass fiber cloth 206, and an area where the electric heating element 203 fits close to the first glass fiber cloth 206 is relative large.

An atomizer is provided according to a second embodiment. The atomizer can further improve the volume of the aerosol generated through atomization and further decrease the temperature of the electric heating element, with respect to that in the first embodiment.

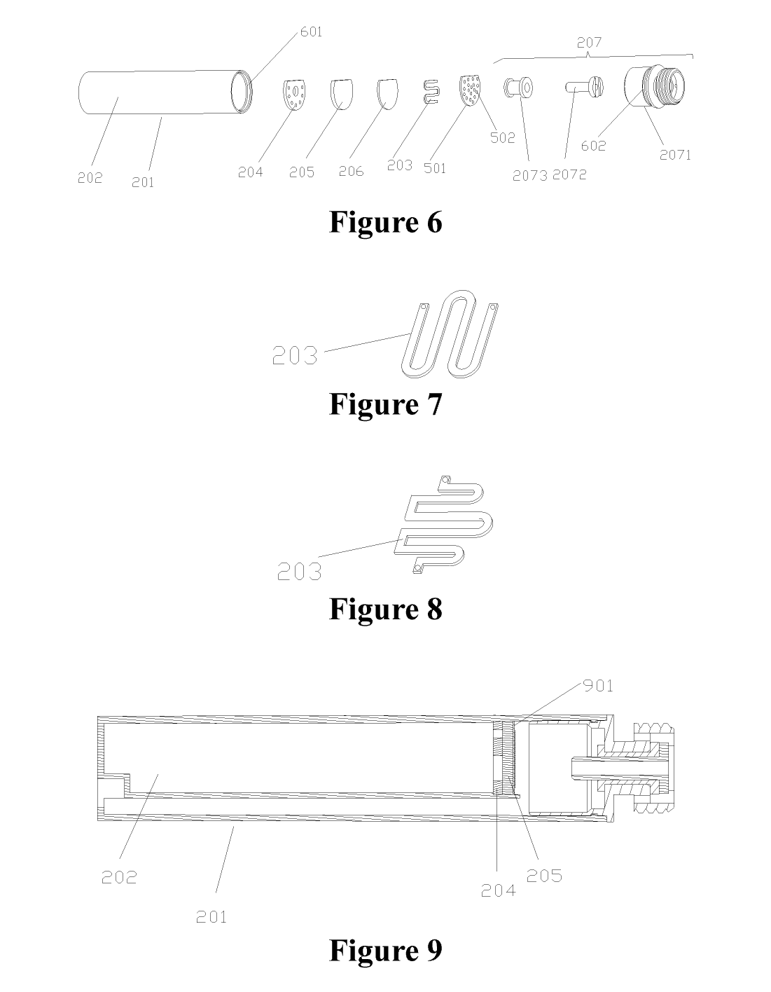

Reference may be made to FIGS. 5 and 6 for the detail.

Specifically, FIG. 5 is a schematic sectional view showing the structure of an atomizer according to the embodiment, and FIG. 6 is a schematic exploded structural view showing the connection between elements of the atomizer according to the embodiment.

As illustrated in FIGS. 5 and 6, with respect to the atomizer according to the first embodiment, in the atomizer according to the embodiment, a second glass fiber cloth 501 is further provided at a side of the electric heating member 203 far away from the cigarette liquid locking member 205, to cover the electric heating element 203, and the second glass fiber cloth 501 abuts against the first glass fiber cloth 205 to transfer the cigarette liquid to the electric heating element 203 to atomize.

With the second glass fiber cloth 501 provided according to the embodiment, both sides of the electric heating element 203 fit close to the glass fiber cloths, such that both sides of the electric heating element 203 may atomize the cigarette liquid to form aerosol, thus further increasing the quantity of the cigarette liquid atomized by the electric heating element 203.

Further, much heat may be generated during the electric heating element 203 atomizing the cigarette liquid to form the aerosol, and if the heat generated in the atomizing process of the cigarette liquid can not be dissipated timely, the cigarette liquid locking member 205 may be burnt. In the embodiment, since both sides of the electric heating element 203 fit close to the glass fiber cloths, the first glass fiber cloth 205 and the second glass fiber cloth 501 may dissipate the heat generated by the electric heating element 203 rapidly, effectively, and timely, thereby effectively avoiding the electric heating element 203 from burning the cigarette liquid locking member 205. Hence, the user experience is ensured, and the service life of the atomizer is effectively prolonged.

If the aerosol, generated through atomization performed by the electric heating element 203, cools and condenses into cigarette liquid, the cigarette liquid may be inhaled by the user, thus negatively affecting the experience of the user during smoking. Therefore, it is required to timely discharge the aerosol generated through the atomization performed by the electric heating element 203, for being inhaled by the user.

In the embodiment, for ensuring that the user can inhale sufficient and non-condensed aerosol, multiple aerosol discharging holes 502 are provided on the second glass fiber cloth 501 (reference may be made to FIG. 6).

Since multiple aerosol discharging holes 502 are provided on the second glass fiber cloth 501, the aerosol generated through the atomization performed by the electric heating element 203 can be discharged rapidly through the aerosol discharging holes 502. Furthermore, with the arrangement of the aerosol discharging holes 502, the discharging of the aerosol is ensured with a better permeability, which further increases the volume of the aerosol atomized by the electric heating element 203, and avoids the cigarette liquid without being atomized from being inhaled by the user while the user can inhale sufficient volume of aerosol.

In a third embodiment, an atomizer is provided, which can effectively save the time consumed in assembling the atomizer, improve the efficiency of assembling the atomizer, and save the manufacture cost, and lower the requirements for an assembly worker.

Specifically, reference may be made to FIGS. 5 and 6.

The atomizing electrode assembly 207 specifically includes a first outer electrode 2071, an insulation ring 2073; and a first inner electrode 2072.

The first outer electrode 2071 is inserted in the atomizer cartridge.

Preferably, the first outer electrode 2071 is provided with a thread section. With the thread section provided, the first outer electrode 2071 may be detachably connected with a battery rod assembly for supplying power to the atomizer.

The insulation ring 2073 is provided inside the first outer electrode.

The first inner electrode 2072 is inserted inside the insulation ring 2073.

That is, the insulation ring 2073 is arranged between the first outer electrode 2071 and the first inner electrode 2072.

In the embodiment, for simplifying the assembly process of the atomizer and improving the assembly efficiency, the electric heating element 203 has one end inserted between the first outer electrode 2071 and the insulation ring 2073, and another end inserted between the first inner electrode 2072 and the insulation ring 2073.

That is, two ends of the electric heating element 203 extend and are respectively inserted into the area between the first outer electrode 2071 and the insulation ring 2073 and the area between the first inner electrode 2072 and the insulation ring 2073, to realize fixing of the electric heating element 203 inside the atomizer.

Alternatively, an electronic wire may be welded at each of both ends of the electric heating element 203, and two electronic wires electrically connected to the electric heating element 203 are respectively inserted into the area between the first outer electrode 2071 and the insulation ring 2073 and the area between the first inner electrode 2072 and the insulation ring 2073.

It is to be noted that, the above arrangement is a preferred example, rather than a limit to the present application. To simplify the assembly, the electric element 203 may have one end inserted into the area between the first outer electrode 2071 and the atomizer cartridge 201 and another end inserted into the first inner electrode 2072 and the insulation ring 2073. The specific arrangement of insertion is not limited in the embodiment, so long as the first inner electrode 2072 and the atomizing electrode assembly are electrically connected by insertion rather than by welding.

With the insertion arrangement shown in the embodiment, the electric heating method 203 is electrically connected to the atomizing electrode assembly by insertion rather than by welding as in conventional technologies. During the specific assembling, it simply requires that two ends of the electric heating element 203 are to be respectively inserted into the area between the first outer electrode 2071 and the insulation ring 2073 and the area between the first inner electrode 2072 and the insulation ring 2073. The atomizer may be assembled without complicated operations, thus facilitating the assembly by the worker, improving the efficiency of the assembly, saving the manufacture cost, and lowering the requirements for the assembly worker.

Further, as shown in FIG. 5, for ensuring the atomizer according to the present embodiment with good sealing such that the cigarette liquid inside the liquid storage chamber 202 would not leak out, an annular protrusion 503 is provided on a circumferential surface of an inner wall of the atomizer cartridge 201 made of a non-metal material, and a groove 504 matching the protrusion 503 is provided on an outer circumferential surface of the first outer electrode 2071 at a position corresponding to that of the protrusion 503.

Alternatively, as shown in FIG. 6, for achieving good sealing of the atomizer, a first thread section 601 may be arranged on the circumferential surface of the inner wall of the atomizer cartridge 201, and a second thread section 602 is arranged on the outer circumferential surface of the first outer electrode 2071 at a position corresponding to that of the first thread section 601. The atomizer cartridge 201 is in thread connection with the first outer electrode 2071 through the thread cooperation between the first thread section 601 and the second thread section 602, such that, the cigarette liquid inside the liquid storage chamber 202 would not leak out, and the atomizer is ensured with good sealing.

Alternatively, an annular sealing plug may be provided at the opening of the liquid storage chamber 202 where abuts against the first outer electrode 2071, and with the annular sealing plug, the cigarette liquid inside the liquid storage chamber 202 would not leak out.

In a third embodiment, specific arrangements of the electric heating element 203 according to the present application are described in detail.

The electric heating element 203 according to the present application may be arranged by the following approaches.

Reference may be made to FIG. 7 for a first approach. The electric heating element 203 is formed by multiple sheet electric heating wires interconnected with each other, the sheet electric heating wires are twisted and laid flat on the first glass fiber cloth 206, so that the electric heating element laid on the first glass fiber cloth 206 has a snakelike structure.

Reference may be made to FIG. 8 for a second approach, that is, directly punching a flat metal block to form an electric heating wire having a snakelike sheet structure, and then laying the sheet electric heating wire flat on the first glass fiber cloth 206, such that the electric heating element 203 laid on the first glass fiber cloth 206 has a snakelike sheet structure.

With respect to the first approach, the electric heating element 203 may be manufactured in a higher efficiency and may have a more reliable structure with the second approach.

It is to be noted that, to provide the electric heating element 203 with a sheet structure, available approaches are not limited to punching. The specific approaches are not limited in the embodiment, so long as the electric heating element 203 has a sheet structure.

Reference may be made to FIG. 9 for a third arrangement approach. A substrate 901 made of a heat resistive material is provided to abut against the cigarette liquid locking member 205.

Preferably, the substrate 901 may be a Flexible Printed Circuit (abbreviated as FPC) board or a ceramic board, the specific material thereof is not limited in the present embodiment, so long as the substrate 901 has an excellent heat resistive performance.

In the embodiment, the substrate 901 is preferably an FPC board, which takes polyimide as a base material. Polyimide has high insulation performance, has no sharp melting point, and may resist a high temperature above 400 Celsius degrees, thus effectively avoiding the burning of the substrate 901 due to high temperature of the electric heating element 203.

Specifically, the substrate 901 has one side provided with a metal layer formed by printing or electroplating a metallic material on the substrate 901 and serving as the electric heating element 203. In the embodiment, the metal layer is an alloy layer which is formed by multiple metallic materials.

More specifically, the alloy layer is a Fe—Cr alloy layer or a nichrome layer. The specific material is not limited in the embodiment, so long as the material can conduct electricity and the cigarette liquid can be accordingly atomized.

That is, a Fe—Cr alloy layer or a nichrome layer is firstly attached on the substrate 901 by electroplating, and then a desired electric heating element 203 is formed by chemical erosion process or cutting. Alternatively, the metal layer may be directly printed on the substrate 901 to form the electric heating element 203, which is not limited here.

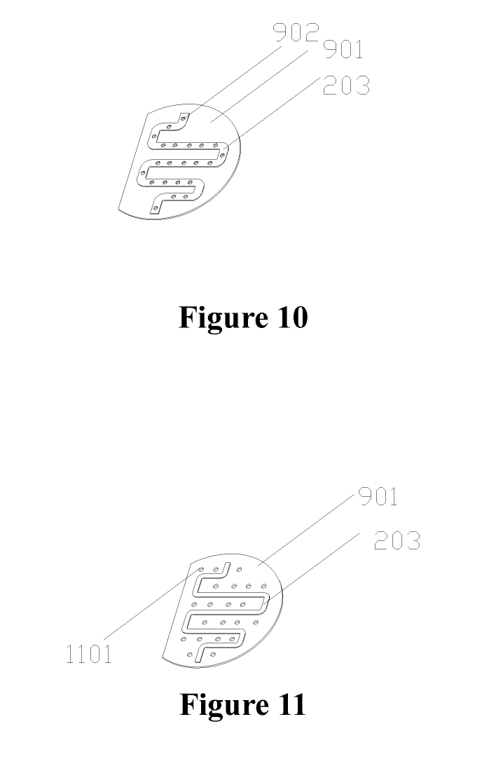

In the approach, for which reference may be made to FIG. 10, one side of the substrate 901 is arranged with the alloy layer, where the side of the substrate 901 is close to the cigarette liquid locking member 205.

It is to be noted that, the specific shape of the electric heating element 203 formed with the alloy layer is not limited in the embodiment, so long as the contact area of the electric heating element 203 in contact with the cigarette liquid locking member 205 can be as large as possible.

The alloy layer is provided with air holes 902 for flow of the aerosol.

The substrate 901 is provided with second through holes at positions corresponding to those of the air holes 902.

That is, in a specific application, the electric heating element 203 formed with the alloy layer contacts the cigarette liquid locking member 205, and atomizes the cigarette liquid stored inside the cigarette liquid locking member 205 to generate the aerosol; the generated aerosol is discharged from the air holes 902 provided on the electric heating element 203, and is discharged into an electronic cigarette body via the second through holes provided on the substrate 901, for being inhaled by the user.

Preferably, a second glass fiber cloth may be further arranged at the other side of the substrate 901. Reference may be made to the above embodiments for the specific arrangement and function of the glass fiber cloth, which are not repeated in the embodiment.

Reference may be made to FIG. 11 for a forth arrangement approach. One side of the substrate 901 is provided with the alloy layer, where the side of the substrate 901 is far away from the cigarette liquid locking member 205.

The substrate 901 is provided with liquid holes 1101 at positions corresponding to that of the alloy layer, for transferring the cigarette liquid to the electric heating element.

That is, during a specific application, the cigarette liquid inside the cigarette liquid locking member 205 is transferred to the electric heating element 203 through the liquid holes 1101 of the substrate 901, the electric heating element 203 atomizes the cigarette liquid transferred via the liquid holes 1101 to generate the aerosol, and the aerosol is discharged into the electronic cigarette body for being inhaled by the user.

Preferably, a second glass fiber cloth may be further provided at the other side of the substrate 901. Reference may be made to the above embodiments for the specific arrangement and function of the glass fiber cloth, which are not repeated in the embodiment.

With the arrangement approaches according to the embodiment, the temperature of the electric heating element 203 can be controlled in a range from 200 Celsius degrees to 320 Celsius degrees, thus avoiding the electric heating element 203 from burning the cigarette liquid locking member 205. Furthermore according to the embodiment, the contact area of the electric heating element 203 in contact with the cigarette liquid locking member 205 is big, such that a large quantity of cigarette liquid can be atomized, thus ensuring the volume of the aerosol for being inhaled by the user and improving the user experience.

An electronic cigarette, in which the atomizer according to the foregoing embodiments is applied, is provided according to a fourth embodiment.

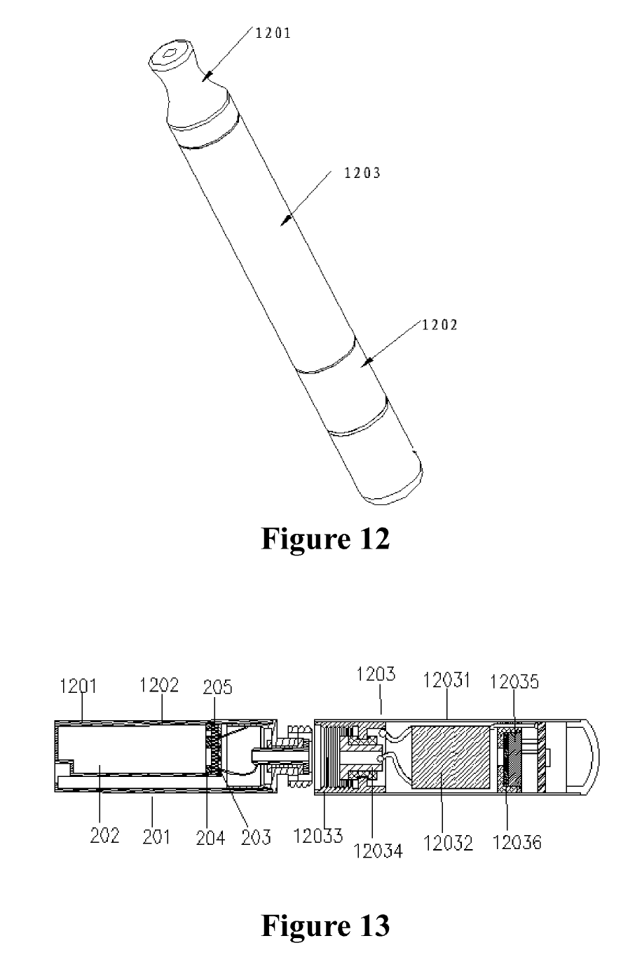

Reference may be made to FIG. 12. The electronic cigarette includes an electronic cigarette body. The electronic cigarette body is provided with a suction end 1201, an atomizer 1202 as described in the foregoing embodiments, and a battery rod assembly 1203 for supplying power to the atomizer 1202. The atomizer 1202 is coaxially arranged with the battery rod assembly 1203, and the atomizer 1202 is detachably connected with the battery rod assembly 1203. With such arrangement, the appearance of the electronic cigarette visually imitates a tobacco cigarette, and an overall aerosol passage is relatively straight, which may reduce liquid accumulation.

Specifically, as shown in FIG. 12, the atomizer 1202 is arranged at one end of the electronic cigarette body away from the suction end 1201.

Advantages of employing such an arrangement are described as follows. Since the atomizer 1202 is arranged away from the suction end 1201, the aerosol passage for flowing of the aerosol inside the electronic cigarette body may not pass the atomizer 1202. Therefore, the cigarette liquid in the atomizer 1202, which is not atomized, may not leak into the aerosol passage, and the user may not inhale the cigarette liquid which is not atomized, thus effectively avoiding leakage of the cigarette liquid. Furthermore, since the aerosol passage does not pass through the atomizer 1202, the aerosol is avoided from condensing in the aerosol passage, thereby effectively avoiding the condensed cigarette liquid from blocking the aerosol passage.

Since the atomizer 1202 is located away from the suction end 1201, when the user smokes with the electronic cigarette according to the embodiment, the atomizer 1201 is relatively far from the mouth of the user. Hence, the user is protected from getting burnt by the heat generated when the atomizer 1202 atomizes the cigarette liquid, which effectively improves safety in using the electronic cigarette. Furthermore, the user may usually clamps the battery rod assembly 1203 rather than the hot atomizer 1202 during smoking, such that the hand of the user may not be burnt when the user uses the electronic cigarette according to the embodiment, thereby effectively imitating the temperature of a tobacco cigarette and improving user experience during smoking.

Specifically, the suction end 1201 is formed by an extension of one end of the battery rod assembly 1203 away from the atomizer, or the suction end 1201 is detachably connected to the end of the battery rod assembly 1203 away from the atomizer 1202.

Preferably, the suction end may be designed to match the mouth shape of the user, thus further facilitating the user smoking and improving the user experience during smoking.

The above arrangement approach of the electronic cigarette body is a preferred arrangement approach, but the electronic cigarette body is not limited to the above arrangement approach. For example, the battery rod assembly may be arranged at one end of the electric cigarette body far away from the suction end. In such arrangement approach, the suction end is formed by an extension of one end of the atomizer far away from the battery rod assembly, or the suction end is detachably connected to the end of the atomizer far away from the battery rod assembly.

The overall outline of the electronic cigarette body may be arranged in an irregular shape, which may be a random shape specifically. Alternatively, the atomizer may be arranged non-coaxially with the battery rod assembly; that is, the atomizer and the battery rod assembly are abreast arranged, such that the overall structure of the electronic cigarette may be in a T-shape.

For facilitating the user to replace the atomizer 1202, the atomizer 1202 is detachably connected with the battery rod assembly 1203. Specifically, a snap-fit approach or a thread connection may be adopted to detachably connect the atomizer 1202 and the battery rod assembly 1203.

Reference may be made to FIG. 13, which is a schematic sectional view showing the structure of an electronic cigarette according to another embodiment of the present application. Reference may be made to the above embodiments for the specific structure of the atomizer shown in FIG. 13, which is not repeated in the embodiment.

The battery rod assembly 1203 includes a battery cartridge 12031, a battery 12032, a second outer electrode 12033, a second inner electrode 12034, a sensor module 12035, and a microcontroller 12036.

The battery 12032 is accommodated inside the battery cartridge 12031.

The second outer electrode 12033 and the second inner electrode 12034 are respectively electrically connected with the battery 12032, where the second outer electrode 12033 is electrically connected to the first outer electrode 2071, and the second inner electrode 12034 is electrically connected to the first inner electrode 2072.

The sensor module 12035 is for generating a triggering signal in response to an operation of the user.

Specifically, in an embodiment, the sensor module 12035 is an airflow sensing switch which senses a sucking action of the user to generate a triggering signal.

The microcontroller 12036, which is for generating a control signal based on the triggering signal, is electrically connected to the sensor module 12035; and the microcontroller 12036 controls, through the control signal, the battery 12032 to supply power to the electric heating element 203.

The technical solutions in the embodiments of the present application are described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the protection scope of the present application.

The above embodiments are described in a progressive manner. Each of the embodiments is mainly focused on describing its differences from other embodiments, and references may be made among these embodiments to understand the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

What is claimed is:

1. An atomizer, comprising:
an atomizer cartridge;
a liquid storage chamber, which is arranged inside the atomizer cartridge and is configured to store a cigarette liquid;
a liquid separation plate, which is arranged at an opening of the liquid storage chamber and is provided with first through holes;
an electric heating element configured to atomize the cigarette liquid to generate an aerosol;
a cigarette liquid locking member, which covers the liquid separation plate and is configured to lock the cigarette liquid to prevent the cigarette liquid in the liquid storage chamber from being overly transferred to the electric heating element;
a first glass fiber cloth, which is arranged between the cigarette liquid locking member and the electric heating element, covers the cigarette liquid locking member, and is configured to transfer the cigarette liquid to the electric heating element to be atomized; and
an atomizing electrode assembly, which is inserted at one end of the atomizer cartridge and electrically connected with the electric heating element;
wherein, the electric heating element twists along the transverse direction of the atomizer and is laid on the first glass fiber cloth, the electric heating element laid on the first glass fiber cloth has a snakelike sheet structure, and a first side face of the electric heating element fits close to a surface of the first glass fiber cloth.

2. The atomizer according to claim 1, wherein a second glass fiber cloth is further provided at one side of the electric heating member and covers the electric heating element, the side of the electric heating member being away from the cigarette liquid locking member, the second glass fiber cloth abuts against the first glass fiber cloth and is configured to transfer the cigarette liquid to the electric heating element to be atomized.

3. The atomizer according to claim 2, wherein the atomizing electrode assembly comprises;
a first outer electrode inserted in the atomizer cartridge;
an insulation ring arranged inside the first outer electrode; and
a first inner electrode inserted inside the insulation ring;
wherein the electric heating element having one end inserted between the first outer electrode and the insulation ring, and another end inserted between the first inner electrode and the insulation ring.

4. The atomizer according to claim 1, wherein the atomizer is made of a non-metallic material, an annular protrusion is provided on a circumferential surface of an inner wall of the atomizer cartridge, and a groove matching the protrusion is provided on an outer circumferential surface of the first outer electrode at a position corresponding to the position of the protrusion.

5. The atomizer according to claim 1, wherein the atomizer further comprises:
a substrate made of a heat resistive material, abutting against the cigarette liquid locking member; and
wherein the substrate has one side provided with a metal layer, and the metal layer is formed by printing or electroplating a metallic material on the substrate and serves as the electric heating element.

6. The atomizer according to claim 5, wherein the metal layer is an alloy layer made of a plurality of metallic materials.

7. The atomizer according to claim 6, wherein
the substrate is provided with the alloy layer at one side close to the cigarette liquid locking member;
the alloy layer is provided with air holes for flowing of the aerosol; and
the substrate is provided with second through holes at positions corresponding to those of the air holes.

8. The atomizer according to claim 6, wherein
the substrate is provided with the alloy layer at one side far away from the cigarette liquid locking member; and
the substrate is provided with liquid holes at positions corresponding to a position of the alloy layer, the liquid holes being configured to transfer the cigarette liquid to the electric heating element.

9. The atomizer according to claim 6, wherein the substrate is a flexible printed circuit board or a ceramic board.

10. An electronic cigarette, comprising an electronic cigarette body; wherein
the electronic cigarette body is provided with a suction end, an atomizer, and a battery rod assembly configured to supply power to the atomizer; wherein the atomizer comprises:
an atomizer cartridge;
a liquid storage chamber, which is arranged inside the atomizer cartridge and is configured to store a cigarette liquid;
a liquid separation plate, which is arranged at an opening of the liquid storage chamber and is provided with first through holes;
an electric heating element configured to atomize the cigarette liquid to generate an aerosol;
a cigarette liquid locking member, which covers the liquid separation plate and is configured to lock the cigarette liquid to prevent the cigarette liquid in the liquid storage chamber from being overly transferred to the electric heating element;
a first glass fiber cloth, which is arranged between the cigarette liquid locking member and the electric heating element, covers the cigarette liquid locking member, and is configured to transfer the cigarette liquid to the electric heating element to be atomized; and
an atomizing electrode assembly, which is inserted at one end of the atomizer cartridge and electrically connected with the electric heating element;
wherein, the electric heating element twists along the transverse direction of the atomizer and is laid on the first glass fiber cloth, the electric heating element laid on the first glass fiber cloth has a snakelike sheet structure, and a first side face of the electric heating element fits close to a surface of the first glass fiber cloth; and
the battery rod assembly is arranged on the electronic cigarette body at one end far away from the suction end, or the atomizer is arranged on the electronic cigarette body at one end far away from the suction end.

11. The electronic cigarette according to claim 10, wherein
the atomizer is coaxially arranged with the battery rod assembly, and the atomizer is detachably connected with the battery rod assembly.

12. The electronic cigarette according to claim 10, wherein the battery rod assembly comprises:
a battery cartridge;
a battery accommodated inside the battery cartridge;
a second outer electrode and a second inner electrode respectively electrically connected with the battery, the second outer electrode being electrically connected with the first outer electrode, and the second inner electrode being electrically connected with the first inner electrode;
a sensor module configured to generate a triggering signal in response to an operation of the user; and
a microcontroller which is electrically connected with the sensor module and is configured to generate a control signal based on the triggering signal, the microcontroller controlling, through the control signal, the battery to supply power to the electric heating element.

13. The electronic cigarette according to claim 10, wherein
the suction end is formed by an extension of one end of the atomizer, the end of the atomizer being far away from the battery rod assembly; or,
the suction end is detachably connected to the end of the atomizer far away from the battery rod assembly.

14. The electronic cigarette according to claim 10, wherein
the suction end is formed by an extension of one end of the battery rod assembly, the end of the battery rod assembly being far away from the atomizer; or,
the suction end is detachably connected to the end of the battery rod assembly far away from the atomizer.

15. The electronic cigarette according to the claim 10, wherein a second glass fiber cloth is further provided at one side of the electric heating member and covers the electric heating element, the side of the electric heating member being away from the cigarette liquid locking member, the second glass fiber cloth abuts against the first glass fiber cloth and is configured to transfer the cigarette liquid to the electric heating element to be atomized.

16. The electronic cigarette according to the claim 15, wherein the atomizing electrode assembly comprises;
a first outer electrode inserted in the atomizer cartridge;
an insulation ring arranged inside the first outer electrode; and
a first inner electrode inserted inside the insulation ring;
wherein the electric heating element having one end inserted between the first outer electrode and the insulation ring, and another end inserted between the first inner electrode and the insulation ring.

17. The electronic cigarette according to the claim 10, wherein the atomizer is made of a non-metallic material, an annular protrusion is provided on a circumferential surface of an inner wall of the atomizer cartridge, and a groove matching the protrusion is provided on an outer circumferential surface of the first outer electrode at a position corresponding to the position of the protrusion.

18. The electronic cigarette according to the claim 10, wherein the atomizer further comprises:
a substrate made of a heat resistive material, abutting against the cigarette liquid locking member; and
wherein the substrate has one side provided with a metal layer, and the metal layer is formed by printing or electroplating a metallic material on the substrate and serves as the electric heating element.

19. The electronic cigarette according to the claim 18, wherein the metal layer is an alloy layer made of a plurality of metallic materials.

20. The electronic cigarette according to the claim 19, wherein
the substrate is provided with the alloy layer at one side close to the cigarette liquid locking member;
the alloy layer is provided with air holes for flowing of the aerosol; and
the substrate is provided with second through holes at positions corresponding to those of the air holes.
